(19) United States
(12) Patent Application Publication
(10) Pub. No.: US 2026/0195574 A1
(43) Pub. Date: Jul. 9, 2026

(54) DYNAMIC PROCESSING IN MEMORY (PIM) ACTIVATION ACCELERATOR ARCHITECTURE

(71) Applicant: QUALCOMM Incorporated, San Diego, CA (US)

(72) Inventors: Vardhana MRUTHYUNJAYA, Mangalore (IN); Jian SHEN, San Diego, CA (US)

(21) Appl. No.: 19/011,191

(22) Filed: Jan. 6, 2025

(51) Int. Cl. G06N 3/048; G06N 3/063

(52) U.S. Cl. CPC G06N 3/048; G06N 3/063

(57) ABSTRACT

Techniques proposed herein provide a dynamic configurable processing in memory (PIM) device architecture for realizing activation functions associated with an artificial intelligence (AI) model and an instruction set architecture (ISA) for dynamically configuring the activation functions that have to be realized or implemented. The ISA may include an indication of one or more activation functions that have to be realized or implemented by a PIM device.

### BACKGROUND

### Field of the Disclosure

Aspects of the present disclosure relate to techniques for managing dynamic activation functions in processing in memory (PIM) systems.

### Description of Related Art

In traditional computing systems, data is stored in a memory, and when a processor needs to process the data, it must first obtain the data from the memory. After the processing, the results are sent back to the memory. This memory-to-processor-to-memory cycle can be slow, especially when dealing with large datasets or complex computations. This latency becomes a bottleneck for performance.

Processing in memory (PIM) is one approach to overcome this inherent latency issue. PIM refers to a computing paradigm in which the data is processed directly in the memory rather than being transferred back and forth between the memory and the processor. The PIM may minimize latency and bottlenecks that come with moving the data between different components, thereby speeding up computation and improving overall performance. The PIM may reduce traffic between the processor and the memory, thereby improving overall bandwidth and system throughput.

### SUMMARY

One aspect provides a method, including: obtaining, by a memory device, a computation task; decoding, by the memory device, one or more instructions from an instruction set architecture (ISA) to identify one or more of a plurality of activation functions to perform the computation task; configuring, by the memory device, one or more of a plurality of programmable computation units (PCUs) of the memory device for implementing the one or more of the plurality of activation functions; and performing, by the memory device, the computation task based on at least in part with implementation of the one or more of the plurality of activation functions.

Other aspects provide: an apparatus operable, configured, or otherwise adapted to perform the aforementioned method as well as those described elsewhere herein; a non-transitory, computer-readable media comprising instructions that, when executed by one or more processors of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system-on-chip (SoC), in accordance with certain aspects of the present disclosure.

FIG. 2 depicts matrix multiplication operations, in accordance with certain aspects of the present disclosure.

FIG. 3 depicts an example processing in memory (PIM) device architecture, in accordance with certain aspects of the present disclosure.

FIG. 4 depicts a flow controller of a PIM device managing execution units (or programmable computation units (PCUs)) of the PIM device for realization of a sigmoid activation function, in accordance with certain aspects of the present disclosure.

FIG. 5 depicts another example PIM device architecture, in accordance with certain aspects of the present disclosure.

FIG. 6 depicts example implementation of a sigmoid activation function, in accordance with certain aspects of the present disclosure.

FIG. 7 depicts example enabling of an activation function via an activation function table stored in a cell array of a PIM device, in accordance with certain aspects of the present disclosure.

FIG. 8 depicts example input and output values for a sigmoid function in an activation function table, in accordance with certain aspects of the present disclosure.

FIG. 9 depicts example instruction set architecture (ISA), in accordance with certain aspects of the present disclosure.

FIG. 10 depicts a method for performing a computation task, in accordance with certain aspects of the present disclosure.

### DETAILED DESCRIPTION

An artificial intelligence (AI) model is a computational system designed to perform tasks that have conventionally required human intelligence. These tasks include recognizing patterns, making decisions, understanding language, and more. AI models are built using algorithms and data to learn and make predictions or decisions based on new, unseen inputs. The AI models may require a huge memory bandwidth and power, and may introduce latency and computation complexities while generating an output.

An activation function in the AI model, particularly in neural networks, is a mathematical function that determines whether a neuron (or node) in a network should be activated (fired) based on an input it receives. In other words, it decides an output of a neuron after it processes the incoming data.

Processing in memory (PIM) refers to a hardware architecture where computation is performed directly within a memory (rather than in a processor). This has the potential to drastically improve performance for certain types of workloads, particularly those involving large amounts of parallel data processing. The PIM may be used for implementation of some AI models. For example, the PIM may focus on some matrix multiplication operations associated with the AI models.

Techniques proposed herein provide a dynamically configurable PIM device architecture for realizing activation functions associated with an AI model and an instruction set architecture (ISA) for dynamically configuring the activation functions that have to be realized or implemented. The ISA may include an indication of one or more activation functions that have to be realized or implemented by a PIM device.

According to certain aspects, separate execution units (e.g., such as programmable computation units (PCUs)) may be provided in the PIM device for realizing different activation functions, and the execution units may be powered up or down individually. For example, the execution units corresponding to the activation functions that have to be realized or implemented may be powered up, while other execution units may be powered down. In another aspect, a shared execution unit may be provided in the PIM device for realizing multiple activation functions.

Particular aspects of the subject matter described in this disclosure can be implemented to realize one or more of the following potential advantages. In some examples, the described techniques may reduce power consumption as unused execution units of the PIM device may be powered down while not in use.

### Example System-on-Chip (SoC)

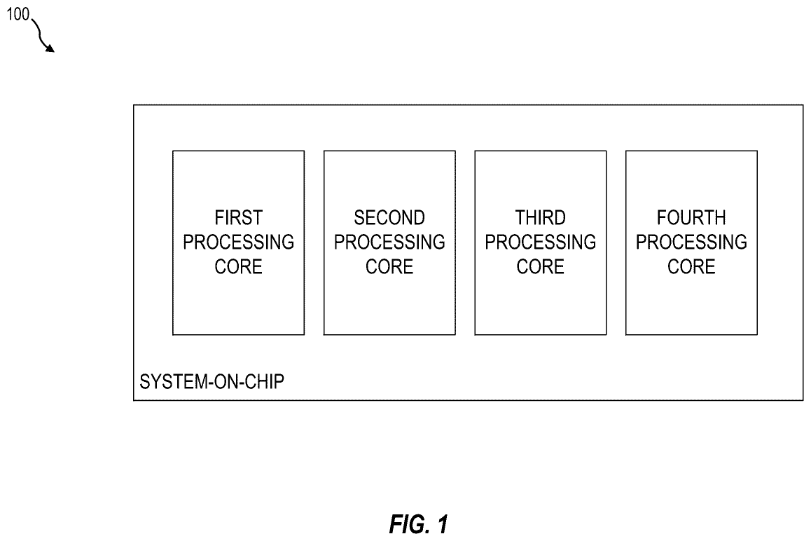

FIG. 1 depicts an example system-on-chip (SoC) 100 with multiple processing cores (e.g., on which artificial intelligence workloads can be processed).

The multiple processing cores may include a first processing core, a second processing core, a third processing core, and a fourth processing core. The first processing core, the second processing core, the third processing core, and the fourth processing core may include efficiency cores and performance cores.

The SoC 100 may further include a graphics processing unit (GPU) and a neural processing unit (NPU), amongst other processing units and components on which various compute workloads can be processed (e.g., tensor processing units, application-specific integrated circuits (ASICs), digital signal processors (DSPs), and the like).

The efficiency cores and the performance cores may be processors implementing a same processing architecture (e.g., processors implementing advanced reduced instruction set computer (RISC) machines (ARM) or RISC-V architectures). The efficiency cores may have a lower performance (e.g., as measured by a number of operations per second that the efficiency cores can perform) than the performance cores, but may use less power than the performance cores in executing a workload.

The GPU may be a specialized processing unit which is configured to perform large mathematical operations (e.g., matrix, vector, tensor, etc. operations) in parallel.

The NPU is a specialized circuit configured for implementing control and arithmetic logic for executing machine learning algorithms, such as algorithms for processing artificial neural networks (ANNs), deep neural networks (DNNs), random forests (RFs), and the like. The NPU may be referred to as a neural signal processor (NSP), a tensor processing unit (TPU), a neural network processor (NNP), an intelligence processing unit (IPU), a vision processing unit (VPU), or a graph processing unit.

The NPU may be configured to accelerate performance of common machine learning tasks, such as image classification, machine translation, object detection, and various other predictive artificial intelligence models. In some examples, a plurality of NPUs may be instantiated on a single chip while in other examples such NPUs may be part of a dedicated neural-network accelerator.

The NPU may be optimized for training or inference, or in some cases configured to balance performance between both. For the NPU that is capable of performing both training and inference, two tasks may still be performed independently.

The NPU designed to accelerate training may be configured to accelerate an optimization of new artificial intelligence models, which is a highly compute-intensive operation that involves inputting an existing dataset (often labeled or tagged), iterating over a dataset, and then adjusting artificial intelligence model parameters, such as weights and biases, in order to improve artificial intelligence model performance. Generally, optimizing based on a wrong prediction involves propagating back through layers of an artificial intelligence model and determining gradients to reduce a prediction error.

The NPU designed to accelerate inference may be configured to operate on complete artificial intelligence models. The NPU may thus be configured to input a new piece of data and rapidly process this new piece through an already trained artificial intelligence model to generate an artificial intelligence model output (e.g., an inference).

Each of the processing units on the SoC 100 (e.g., the efficiency cores, the performance cores, the GPU, the NPU, and/or other processing units not illustrated in FIG. 1) may have different performance characteristics. The performance characteristics may include a power slope, a leakage power, a dynamic clock and voltage scaling points (e.g., points at which processing core clock speed and voltage draw scales upward or downward), instructions-per-clock cycle (IPC) performance levels, and the like.

Workloads executing on the SoC 100 may be defined by various characteristics which may influence how these workloads, or portions thereof, are scheduled for execution on various processing units of the SoC 100. For example, the workloads may be characterized by a number of stages (e.g., layers) in an artificial intelligence model executing on the SoC 100, a length of an input into the artificial intelligence model, data types associated with each stage or layer of the artificial intelligence model.

### Example Activation Functions

In artificial neural networks, activation functions are mathematical functions applied to an output of each neuron (or node) in a network. Their primary purpose is to introduce non-linearity into the network, enabling it to learn and model complex relationships between inputs and outputs. Without activation functions, a neural network would essentially behave like a linear model, regardless of how many layers it has.

The activation functions help the network to make decisions or predictions, learn from data, and improve during a training process. The activation functions determine the output of a neuron based on the input it receives, which is the weighted sum of the inputs plus a bias term.

The activation functions allow neural networks to approximate non-linear functions and model complex patterns that linear functions cannot. By stacking multiple layers with non-linear activation functions, the neural networks can learn hierarchical representations of data, making them powerful tools for tasks like image recognition, natural language processing, and more.

A sigmoid function, also known as a logistic function, is a mathematical function used in machine learning and neural networks. The sigmoid function maps any real-valued input to a value between 0 and 1, making it useful for binary classification tasks and probability estimation. The sigmoid function is smooth and continuous, and it has a well-defined derivative, which makes it suitable for gradient-based optimization techniques (like backpropagation) in neural networks. The sigmoid function introduces non-linearity into a model, enabling neural networks to learn complex patterns. Without a non-linear activation function like sigmoid, neural networks would only be able to model linear relationships. The sigmoid function saturates for very large or very small input values. That means if the input is either very positive or very negative, the function's output becomes very close to 0 or 1, making it insensitive to further changes in the input.

A hyperbolic tangent (Tanh) function is a type of activation function used in neural networks. Like the sigmoid function, the tanh function is a non-linear function, but it has different properties that make it preferable in some cases. The tanh function maps any real-valued input to a range between −1 and 1. The tanh function has an “S” shape, but its output is zero-centered. This makes it more suitable for certain types of neural networks because it helps mitigate issues with gradient-based optimization. The tanh function is smooth and continuous, and it is differentiable, which is important for backpropagation during training in neural networks. One key difference between the tanh and sigmoid functions is that tanh is zero-centered. This means that its output ranges from −1 to 1, unlike the sigmoid, which outputs values between 0 and 1. Zero-centered outputs can help improve the convergence of training, as they reduce the tendency of the gradients to be biased in a particular direction. The tanh function is symmetric around the origin, unlike the sigmoid, which is biased towards the positive side. This symmetry allows for better weight updates during training, as the network can adjust both positive and negative weights more effectively.

A rectified linear unit (ReLU) activation function is one of the most widely used activation functions in modern deep learning and neural networks, especially for hidden layers. It is a simple, efficient, and computationally inexpensive function that helps neural networks learn faster and avoids some of the limitations of older activation functions like the sigmoid and tanh functions.

A gaussian error linear unit (GELU) is a smooth, non-linear activation function that combines the properties of a Gaussian distribution with a ReLU-like function. It has become increasingly popular in deep learning, as it has been found to perform well in terms of both training stability and model performance. The GELU function is a smooth, probabilistic activation function that can be seen as a “soft” version of the ReLU function. Unlike ReLU, which simply zeros out negative values, GELU introduces a probabilistic element where negative inputs are scaled by a small factor instead of being hard-cut to zero. This soft thresholding is inspired by the properties of the Gaussian distribution.

A softmax function is a widely used activation function, especially in the context of multi-class classification problems in machine learning and neural networks. It converts a vector of raw scores (often called logits) into probabilities by scaling the values in the vector so that they sum to 1. This makes it particularly useful for multi-class classification, where we need to predict a probability distribution over multiple classes. The softmax function uses the exponential of the logits to scale the raw scores. This has the effect of amplifying larger scores and suppressing smaller scores, which helps a model focus on the most likely classes. The softmax function normalizes the raw logits by dividing each exponentiated value by the sum of all exponentiated logits. This ensures that the output is a valid probability distribution. The softmax is sensitive to the relative differences between the logits. A large positive logit will result in a higher probability, while a large negative logit will result in a lower probability. Even small differences in logits can lead to significant differences in the resulting probabilities.

An exponential linear unit (ELU) is an activation function introduced as an improvement over ReLU to address some of its limitations, particularly in terms of learning and optimization in deep neural networks. The ELU is designed to provide better performance and faster convergence by introducing non-linearity and improving the behavior of the network during training. The ELU function has a smooth curve that is continuous and differentiable. For positive inputs, the output is linear (similar to ReLU), and for negative inputs, the function transitions smoothly into negative values with exponential growth. One major advantage of the ELU over the ReLU is that it avoids the dying ReLU problem, where neurons can become inactive (outputting zero for all inputs) for negative values. This happens because the exponential part of ELU ensures that negative values are still “active” and contribute to learning, even for negative inputs. The ELU function is zero-centered for negative values, unlike ReLU which only produces non-negative outputs. This means the output of ELU has both positive and negative values, which can help the optimization process converge more efficiently by keeping the gradients centered around zero, reducing bias in weight updates.

### Example Implementation of Artificial Intelligence (AI) Model Activation Functions

An artificial intelligence (AI) model is a computational system designed to perform tasks that typically require human intelligence. These tasks include recognizing patterns, making decisions, understanding language, and more. AI models are built using algorithms and data to learn and make predictions or decisions based on new, unseen inputs. The AI models may require a huge memory bandwidth and power consumption, and may introduce latency and computation complexities while generating an output.

An activation function in the AI model, particularly in neural networks, is a mathematical function that determines whether a neuron (or node) in a network should be activated (fired) based on an input it receives. In other words, it decides an output of a neuron after it processes the incoming data.

Activation functions in the AI model may be implemented as part of a software. The software implementation of the activation functions may consume large computation cycles and introduces memory latency. The large computation cycles may require more power usage.

The implementation of multiple activation functions in the AI model may also require multiple hardware accelerators (e.g., one hardware accelerator for each activation function). A hardware accelerator may be a physical component or device designed to perform specific tasks more efficiently than a general-purpose central processing unit (CPU). The accelerator is optimized for particular functions, significantly speeding up processing tasks that would normally be handled by a general-purpose processor. There are various types of the hardware accelerators, and they are used to offload and accelerate specific workloads, providing improved performance, reduced latency, and lower energy consumption in comparison to relying on software running on a standard CPU. The use of the multiple hardware accelerators for the implementation of the multiple activation functions in the AI model may consume more power.

Processing in memory (PIM) refers to a hardware architecture where computation is performed directly within a memory (rather than in a processor). This can drastically improve performance for certain types of workloads, particularly those involving large amounts of parallel data processing. The PIM aims to reduce a need for data to travel between the processor and the memory, which can be a significant bottleneck in traditional computer architectures.

The memory may include embedded processing units. For example, a specialized hardware like high-performance dynamic random access memory (DRAM) chips may include one or more processing cores to handle certain operations directly in the memory, such as mathematical computations. A processing core is capable of executing instructions, performing calculations, and handling tasks. Multiple processing cores may work together to process data in parallel, allowing for increased performance, multitasking, and efficiency.

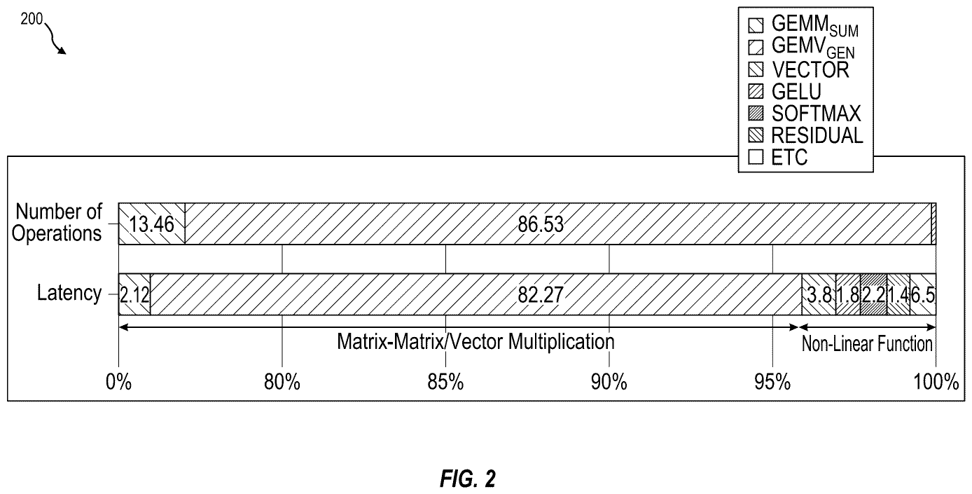

The PIM may be used for implementation of some AI models. For example, the PIM may focus on matrix multiplication operations such as general matrix multiply (GEMM) and general matrix vector multiplication (GEMV), as illustrated in a diagram 200 of FIG. 2. The GEMV may be a fundamental linear algebra operation that involves multiplying a matrix by a vector. This operation is widely used in various scientific, engineering, and machine learning applications, particularly in solving systems of linear equations, optimization problems, and in neural networks. However, the PIM may not currently focus on the implementation of some activation functions (e.g., non-linear functions such as a vector function, a gaussian error linear unit (GELU) function, a softmax function, a residual function, etc. as depicted in the diagram 200 of FIG. 2) that may contribute to 10% or more latency (e.g., for generative pretrained transformer (GPT) token generation stage).

### Example Dynamic PIM Activation Accelerator Architecture

Techniques proposed herein provide a dynamic configurable processing in memory (PIM) device architecture for activation functions and an instruction set architecture (ISA) for dynamically configuring the activation functions. For example, the ISA may include an indication of one or more activation functions that a user may want to implement.

In one aspect, separate execution units (e.g., such as programmable computation units (PCUs)) may be provided in a PIM device (or a memory device) for different activation functions, and the execution units may be powered up or down individually.

In another aspect, a shared execution unit may be provided in the PIM device for the different activation functions, and the shared execution unit may be configured to realize one or more required activation functions as per instructions during runtime.

In another aspect, a table (e.g., a runtime table) may be provided to store activation function tables in a cell array of the PIM device. A user may look up the runtime table to realize one or more required activation functions as per instructions. The use of the runtime table may prevent the need for execution units in the PIM device and this may reduce logic area (e.g., space used for the execution units) of the PIM device.

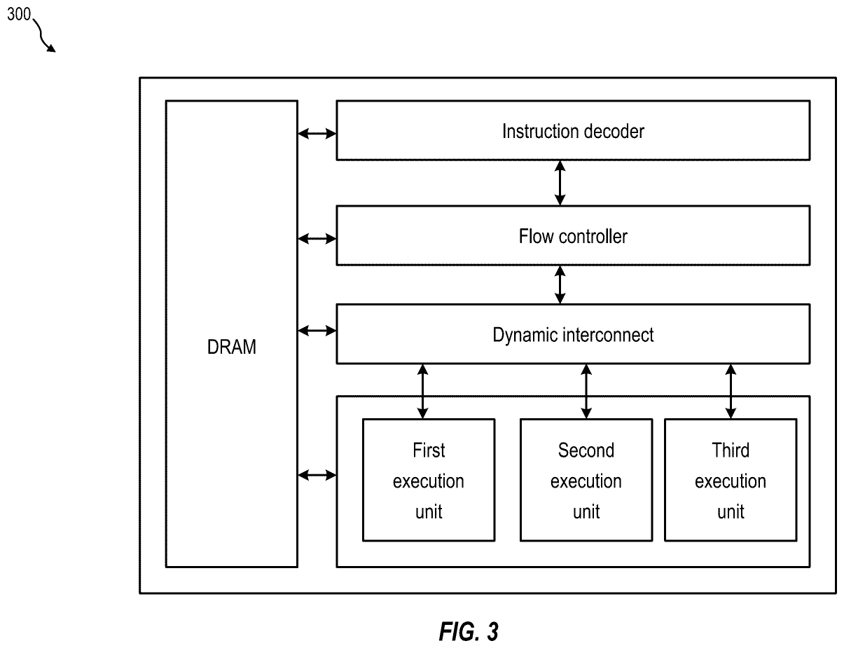

The techniques proposed herein may be further understood with reference to FIG. 3-FIG. 10.

FIG. 3 depicts a diagram 300 illustrating PIM device architecture. A PIM device may include multiple components that are associated with each other. For example, the PIM device may include a dynamic random access memory (DRAM), an instructions decoder, a flow controller, a dynamic interconnect, and/or execution units.

The DRAM may be a volatile memory used in the PIM device to store data and/or instructions that are actively being used or processed. The DRAM is volatile, meaning it loses its stored data and/or instructions when the power is turned off. This is in contrast to non-volatile memory types like flash memory or hard drives that retain data and/or instructions even when powered off. The DRAM is called dynamic because it needs to be constantly refreshed to maintain its data and/or instructions. Unlike static random access memory (SRAM), which holds data and/or instructions as long as power is supplied, the DRAM stores data and/or instructions in capacitors that leak charge over time. To prevent data loss, a system periodically refreshes the contents of these capacitors. The DRAM allows data and/or instructions to be accessed in any order, not sequentially. This makes it very fast for read and write operations, which is essential for system memory where quick access to data and/or instructions is required. The DRAM consists of a matrix of cells arranged in rows and columns. Each cell holds a bit of data and/or instructions, represented by an electrical charge in a capacitor, with a transistor acting as a switch to access the data and/or instructions.

The instructions decoder may translate instructions (e.g., machine-level instructions in binary or assembly language) into signals that can direct the PIM device various subsystems (e.g., the flow controller) to carry out a specified operation. The instructions decoder is a part of the PIM device control unit, and its primary job is to interpret the instructions. The instruction decoder may take the instructions and decode the instructions into control signals that other components of the PIM device can use. Once decoded, the instruction decoder generates control signals that manage other components of the PIM device. For example, the control signals may guide the execution of an operation, such as add two values or to read/write data.

The flow controller may manage a control flow of instructions from the instructions decoder during the execution of a program. The flow controller plays a crucial role in determining an order in which instructions from the instructions decoder are fetched, decoded, and/or executed, especially when dealing with complex control structures like loops, branches, or function calls in a program. The flow controller determines a sequence in which the instructions from the instructions decoder are fetched. In a simple program, this might just mean fetching a next instruction in the sequence (e.g., instruction 1, then instruction 2, etc.). However, in more complex programs, the flow can change based on conditional statements, loops, or branches.

The dynamic interconnect may refer to a flexible, adaptive system used to connect different components within the PIM device, such as the execution units, cores, and other functional units. Unlike traditional static interconnects, which are fixed and unchanging, dynamic interconnects can adjust their bandwidth, routing paths, and priorities based on workload demands, enabling more efficient communication and data transfer within the PIM device.

The execution units are hardware components designed to execute a variety of computational tasks based on software instructions. The execution units are central to the functionality of the PIM device, enabling flexible and efficient execution of diverse algorithms. The execution units may include a first execution unit (e.g., for performing exponent operations), a second execution unit (e.g., for performing addition operations), and a third execution unit (e.g., for performing division operations).

In some aspects, the instructions decoder may decode instructions corresponding to one or more activation functions that have to be implemented or realized. The instructions decoder may send the decoded instructions to the flow controller. Based on the decoded instructions, the flow controller may configure or program the dynamic interconnect to place (or use) one or more (shared) execution units (e.g., computation blocks) in a particular order or sequence to realize the one or more activation functions as per the decoded instructions.

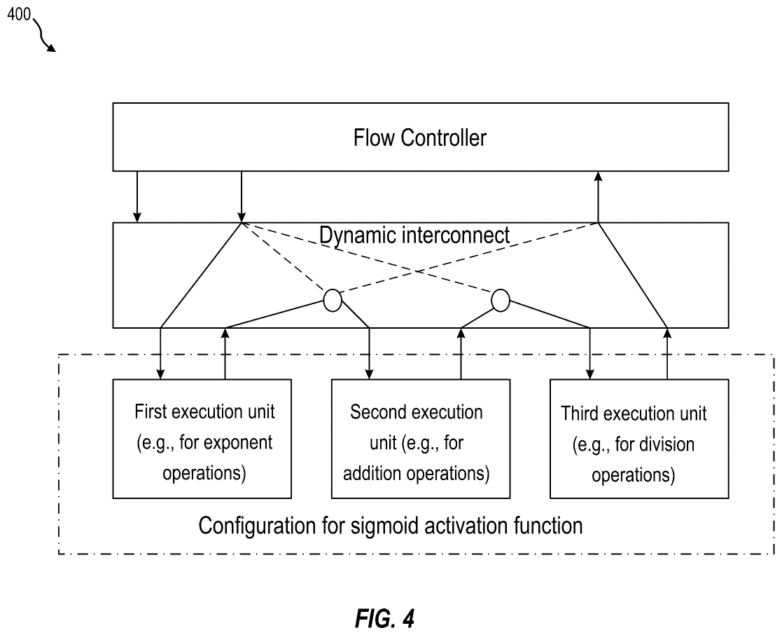

FIG. 4 depicts a diagram 400 illustrating realization of a sigmoid activation function. For example, a flow controller may receive information from an instructions decoder to realize the sigmoid activation function. The instructions decoder may determine that the sigmoid activation function has to be realized based on decoding of instructions per ISA.

The flow controller may configure the dynamic interconnect to manage data transfer and/or flow between a first execution unit (e.g., for performing exponent operations), a second execution unit (e.g., for performing addition operations), and a third execution unit (e.g., for performing division operations). The flow controller may arrange the execution units in an order of computation to realize the sigmoid activation function.

A connection provided by the dynamic interconnect between the execution units may vary as per an activation function to be realized. For example, to realize the sigmoid activation function, the first execution unit may be implemented followed by the second execution unit followed by the third execution unit. For example, the flow controller may send data to the first execution unit for processing. An output of the first execution unit may be sent to the second execution unit for processing. An output of the second execution unit may be sent to the third execution unit for processing. The third execution unit sends a final output to the flow controller.

The flow controller may implement one or more registers for storage of the data being processed by the different execution units.

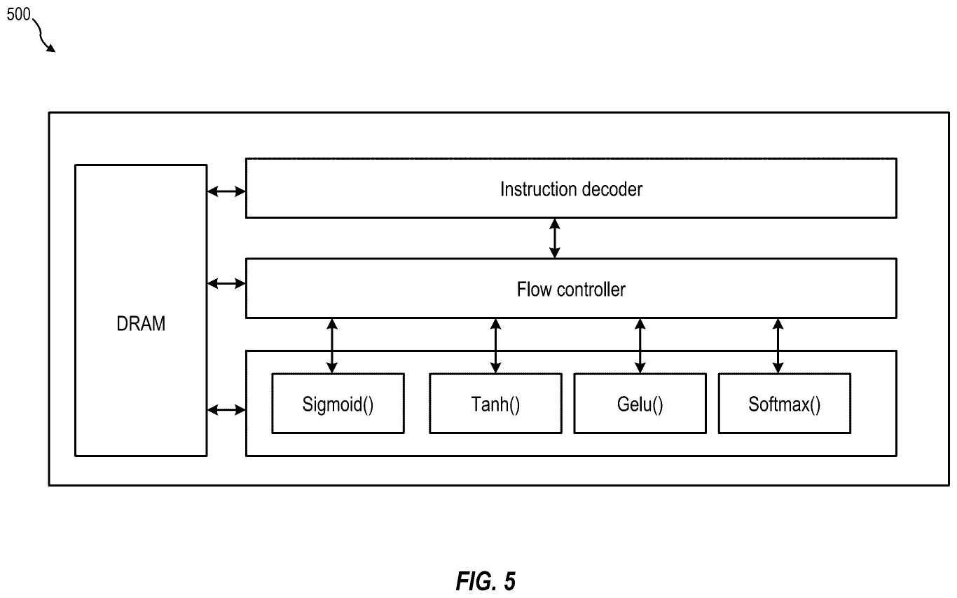

FIG. 5 depicts a diagram 500 illustrating another PIM device architecture. A PIM device may include multiple components that are associated with each other. For example, the PIM device may include a DRAM, an instructions decoder, a flow controller, and/or multiple activation function modules for different activation functions. The activation function modules may also be called as execution units.

The activation function modules may include a first activation function module for realizing a sigmoid function, a second activation function module for realizing a hyperbolic tangent (Tanh) function, a third activation function module for realizing a gaussian error linear unit (GELU) function, and a fourth activation function module for realizing a softmax function.

In some aspects, the instructions decoder may decode instructions corresponding to one or more activation functions that have to be implemented or realized. The instructions decoder may send the decoded instructions to the flow controller. Based on the decoded instructions, the flow controller may enable or execute one or more activation function modules corresponding to the one or more activation functions that have to be implemented or realized. The flow controller may disable or power down the activation function modules that are not used to reduce power consumption of the PIM device.

For example, all activation function modules may initially be in a sleep mode. Based on the decoded instructions, the flow controller may determine to enable or execute the first activation function module for realizing or implementing the sigmoid function. The flow controller may then only enable the first activation function module. Other activation function modules may remain in the sleep mode or in power down mode.

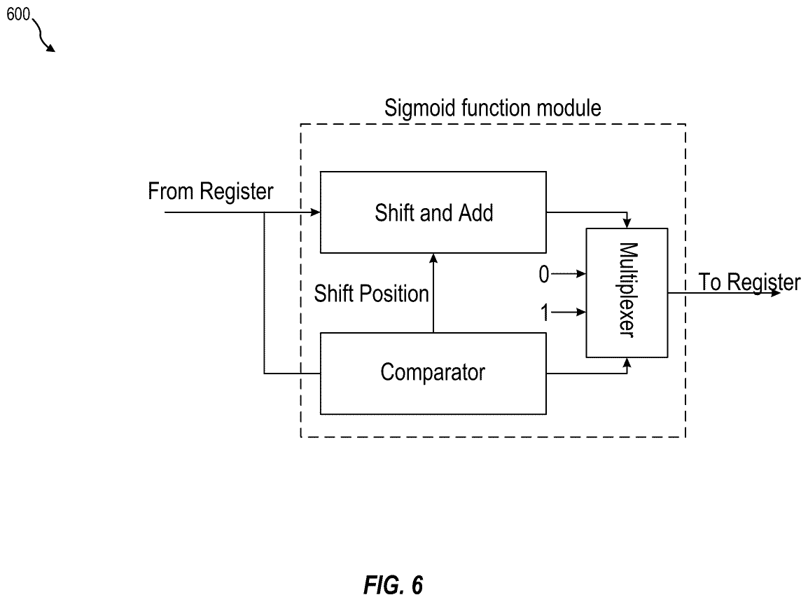

FIG. 6 depicts a diagram 600 illustrating a sigmoid function module for realizing or implementing a sigmoid function. The sigmoid function is a mathematical function used in artificial neural networks. The sigmoid function maps input values to an output range between 0 and 1, making it useful for tasks like binary classification and probability prediction.

The sigmoid function module may include a shift and add sub-module, a comparator sub-module, and/or a multiplexer module for realizing or implementing the sigmoid function. One or more values from a register may be inputted to the sigmoid function module (i.e., into its various sub-modules such as the shift and add sub-module, the comparator sub-module, and/or the multiplexer module). The various sub-modules of the sigmoid function module may perform one or more operations on the inputted values. The sigmoid function module may generate output values, which are then written back in the register.

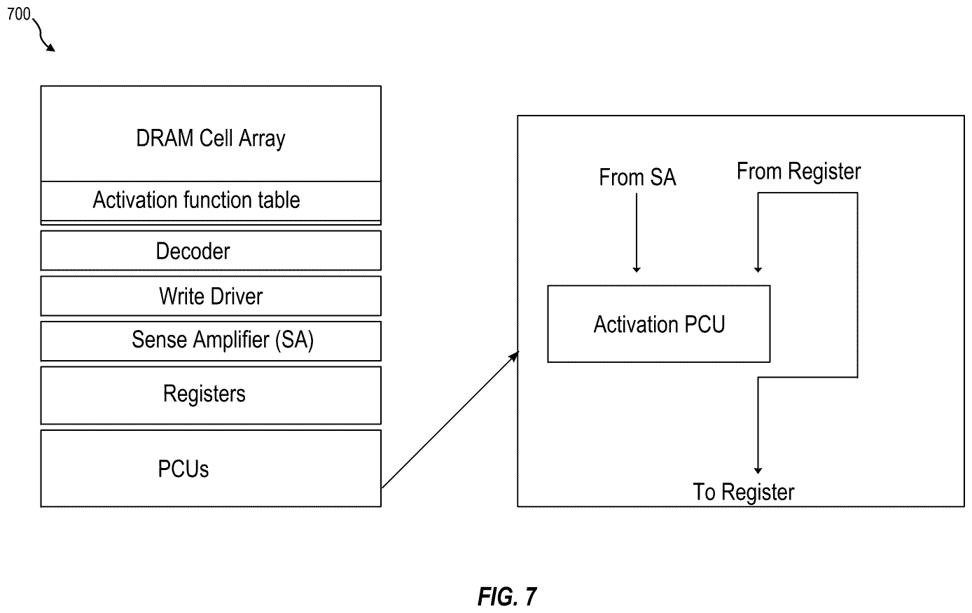

FIG. 7 depicts a diagram 700 illustrating enabling of an activation function via an activation function table stored in a DRAM cell array of a PIM device. For example, the DRAM cell array may include the activation function table, a decoder, a write driver, a sense amplifier, registers, and PCUs (or execution units) for different activation functions. The activation function table may store input values and approximate output values for one or more activation functions. In one example, the activation function table may store input values and approximate output values for a sigmoid function. In another example, the activation function table may store input values and approximate output values for a softmax function.

In some aspects, the DRAM cell array may be loaded with the activation function table to approximate activation functions. In some aspects, the activation function table may be loaded from a flash during the PIM device power on operation.

In some aspects, an instructions decoder may decode instructions corresponding to an activation function (e.g., the sigmoid function) that has to be implemented or realized. The instructions decoder may send the decoded instructions to the flow controller. Based on the decoded instructions, the flow controller may determine to enable or execute the sigmoid function based on the activation function table. For example, the flow controller may determine output values for the sigmoid function for any input values obtained from a register using the activation function table. The determined output values are written back in the register by the flow controller.

In some aspects, based on the instructions corresponding to the sigmoid function that has to be implemented or realized, the instructions decoder may determine the output values for the sigmoid function for any input values obtained from the register using the activation function table. The determined output values are written back in the register by the instructions decoder.

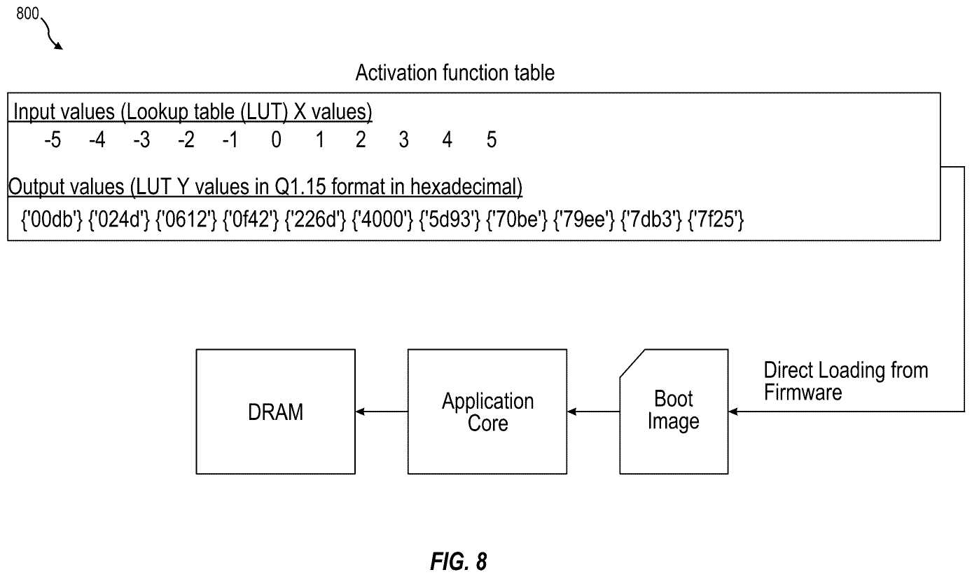

FIG. 8 depicts a diagram 800 illustrating input values and approximate output values for a sigmoid function in an activation function table (such as a look up table). For a certain input value X obtained from a register for which the sigmoid function has to be realized, an instructions decoder may determine a corresponding sigmoid output value Y from the activation function table.

In some aspects, the input values and the approximate output values for the sigmoid function in the activation function table may be stored externally or embedded as part of a boot image. An application core may load the boot image in a DRAM of a PIM device during a power on operation of the PIM device.

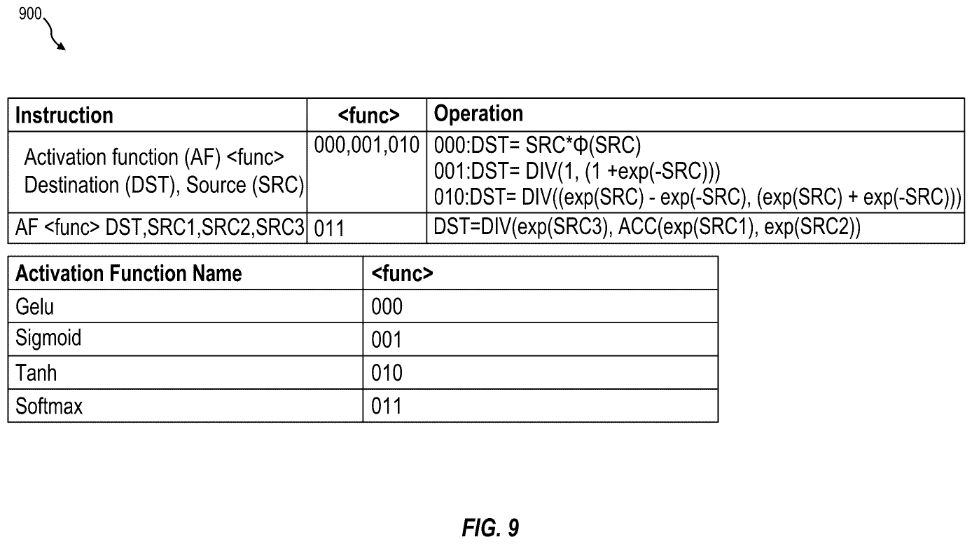

FIG. 9 depicts a diagram 900 illustrating an ISA. The ISA may include instructions for realizing one or more activation functions (and their corresponding operations).

In some aspects, the instructions may include “000”, which may indicate to realize a GELU function and its corresponding operation.

In some aspects, the instructions may include “001”, which may indicate to realize a sigmoid function and its corresponding operation.

In some aspects, the instructions may include “010”, which may indicate to realize a Tanh function and its corresponding operation.

In some aspects, the instructions may include “011”, which may indicate to realize a softmax function and its corresponding operation.

In some aspects, the instructions may further include destination information (DST) and source information (SRC).

### Example Method for Performing a Computation Task

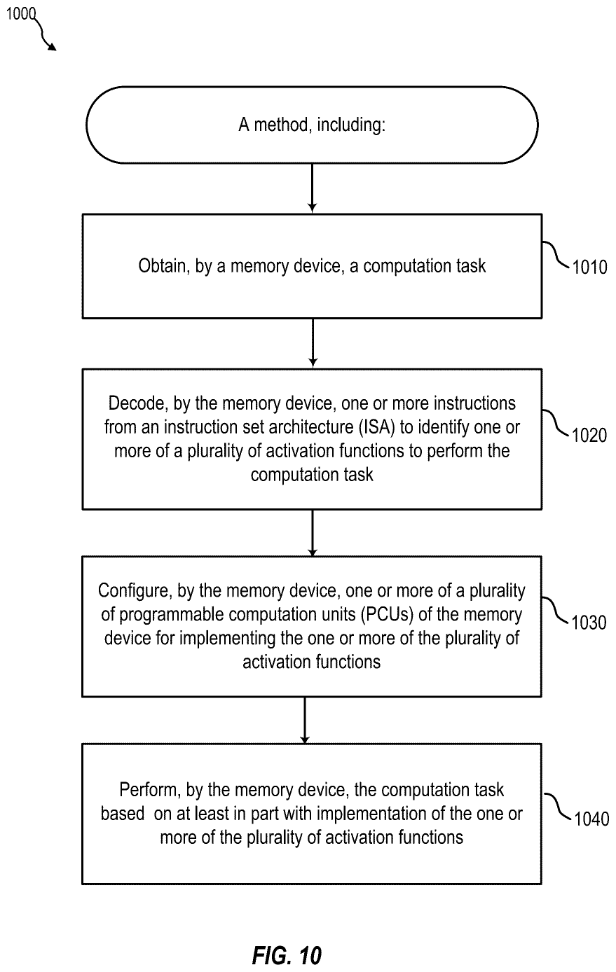

FIG. 10 depicts a method 1000 for performing a computation task. The method 100 may be performed by a memory device. The memory device may be used in a wearable device or an extended reality device.

The method 1000 begins at 1010 with obtaining by the memory device a computation task.

The method 1000 at 1020 includes decoding by the memory device one or more instructions from an instruction set architecture (ISA) to identify one or more of a plurality of activation functions to perform the computation task.

The method 1000 at 1030 includes configuring by the memory device one or more of a plurality of programmable computation units (PCUs) of the memory device for implementing the one or more of the plurality of activation functions.

The method 1000 at 1040 includes performing by the memory device the computation task based on at least in part with implementation of the one or more of the plurality of activation functions.

In certain aspects, the plurality of activation functions include at least one of: a sigmoid activation function, a softmax activation function, a hyperbolic tangent activation function, a gaussian error linear unit (GELU) activation function, or an exponential linear unit (ELU) activation function.

In certain aspects, the method 1000 further includes configuring at least one of the plurality of PCUs to implement two or more of the plurality of activation functions to perform the computation task.

In certain aspects, the method 1000 further includes associating a flow controller of the memory device with a dynamic interconnect component of the memory device; and associating the dynamic interconnect component with the plurality of PCUs.

In certain aspects, the method 1000 further includes configuring, by the flow controller, the dynamic interconnect component based on the computation task, to control data transfer between the plurality of PCUs to perform the computation task.

In certain aspects, the method 1000 further includes arranging, by the flow controller, an order of execution of each of the plurality of PCUs to perform the computation task, based on the computation task.

In certain aspects, the method 1000 further includes configuring each of the plurality of PCUs to implement a different activation function from the plurality of activation functions.

In certain aspects, the method 1000 further includes associating a flow controller of the memory device with the plurality of PCUs.

In certain aspects, the method 1000 further includes determining, by the flow controller, a first subset of the plurality of PCUs that are required to perform the computation task and a second subset of the plurality of PCUs that are not required to perform the computation task, based on the computation task.

In certain aspects, the method 1000 further includes enabling, by the flow controller, the first subset of the plurality of PCUs to perform the computation task.

In certain aspects, the method 1000 further includes configuring a look up table, the look up table includes input values and output values for the plurality of activation functions; and storing the look up table in a random access memory (RAM) component of the memory device.

In certain aspects, the method 1000 further includes enabling, by an instruction decoder of the memory device, the one or more of the plurality of activation functions to perform the computation task via the look up table.

In certain aspects, the enabling of the one or more of the plurality of activation functions via the look up table includes obtaining the output values based on the one or more of the plurality of activation functions for the input values per the computation task via the look up table.

### Example Clauses

Implementation examples are described in the following numbered clauses:
Clause 1: A method, comprising: obtaining, by a memory device, a computation task; decoding, by the memory device, one or more instructions from an instruction set architecture (ISA) to identify one or more of a plurality of activation functions to perform the computation task; configuring, by the memory device, one or more of a plurality of programmable computation units (PCUs) of the memory device for implementing the one or more of the plurality of activation functions; and performing, by the memory device, the computation task based on at least in part with implementation of the one or more of the plurality of activation functions.
Clause 2: The method of clause 1, wherein the plurality of activation functions comprise at least one of: a sigmoid activation function, a softmax activation function, a hyperbolic tangent activation function, a gaussian error linear unit (GELU) activation function, or an exponential linear unit (ELU) activation function.
Clause 3: The method of any one of clauses 1-2, further comprising configuring at least one of the plurality of PCUs to implement two or more of the plurality of activation functions to perform the computation task.
Clause 4: The method of clause 3, further comprising: associating a flow controller of the memory device with a dynamic interconnect component of the memory device; and associating the dynamic interconnect component with the plurality of PCUs.
Clause 5: The method of clause 4, further comprising configuring, by the flow controller, the dynamic interconnect component based on the computation task, to control data transfer between the plurality of PCUs to perform the computation task.
Clause 6: The method of clause 4, further comprising arranging, by the flow controller, an order of execution of each of the plurality of PCUs to perform the computation task, based on the computation task.
Clause 7: The method of any one of clauses 1-6, further comprising configuring each of the plurality of PCUs to implement a different activation function from the plurality of activation functions.
Clause 8: The method of clause 7, further comprising associating a flow controller of the memory device with the plurality of PCUs.
Clause 9: The method of clause 8, further comprising determining, by the flow controller, a first subset of the plurality of PCUs that are required to perform the computation task and a second subset of the plurality of PCUs that are not required to perform the computation task, based on the computation task.
Clause 10: The method of clause 9, further comprising enabling, by the flow controller, the first subset of the plurality of PCUs to perform the computation task.
Clause 11: The method of any one of clauses 1-10, wherein: the configuring further comprises configuring a look up table, the look up table comprises input values and output values for the plurality of activation functions; and storing the look up table in a random access memory (RAM) component of the memory device.
Clause 12: The method of clause 11, further comprising enabling, by an instruction decoder of the memory device, the one or more of the plurality of activation functions to perform the computation task via the look up table.
Clause 13: The method of clause 12, wherein the enabling of the one or more of the plurality of activation functions via the look up table comprises obtaining the output values based on the one or more of the plurality of activation functions for the input values per the computation task via the look up table.
Clause 14: An apparatus, comprising: at least one memory comprising instructions; and one or more processors configured, individually or in any combination, to execute the instructions and cause the apparatus to perform a method in accordance with any one of Clauses 1-13.
Clause 15: An apparatus, comprising means for performing a method in accordance with any one of Clauses 1-13.
Clause 16: A non-transitory computer-readable medium comprising executable instructions that, when executed by one or more processors of an apparatus, cause the apparatus to perform a method in accordance with any one of Clauses 1-13.
Clause 17: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
obtaining, by a memory device, a computation task;
decoding, by the memory device, one or more instructions from an instruction set architecture (ISA) to identify one or more of a plurality of activation functions to perform the computation task;
configuring, by the memory device, one or more of a plurality of programmable computation units (PCUs) of the memory device for implementing the one or more of the plurality of activation functions; and
performing, by the memory device, the computation task based on at least in part with implementation of the one or more of the plurality of activation functions.

2. The method of claim 1, wherein the plurality of activation functions comprise at least one of:
a sigmoid activation function,
a softmax activation function,
a hyperbolic tangent activation function,
a gaussian error linear unit (GELU) activation function, or
an exponential linear unit (ELU) activation function.

3. The method of claim 1, further comprising configuring at least one of the plurality of PCUs to implement two or more of the plurality of activation functions to perform the computation task.

4. The method of claim 3, further comprising:
associating a flow controller of the memory device with a dynamic interconnect component of the memory device; and
associating the dynamic interconnect component with the plurality of PCUs.

5. The method of claim 4, further comprising configuring, by the flow controller, the dynamic interconnect component based on the computation task, to control data transfer between the plurality of PCUs to perform the computation task.

6. The method of claim 4, further comprising arranging, by the flow controller, an order of execution of each of the plurality of PCUs to perform the computation task, based on the computation task.

7. The method of claim 1, further comprising configuring each of the plurality of PCUs to implement a different activation function from the plurality of activation functions.

8. The method of claim 7, further comprising associating a flow controller of the memory device with the plurality of PCUs.

9. The method of claim 8, further comprising determining, by the flow controller, a first subset of the plurality of PCUs that are required to perform the computation task and a second subset of the plurality of PCUs that are not required to perform the computation task, based on the computation task.

10. The method of claim 9, further comprising enabling, by the flow controller, the first subset of the plurality of PCUs to perform the computation task.

11. The method of claim 1, wherein:
the configuring further comprises configuring a look up table, the look up table comprises input values and output values for the plurality of activation functions; and
storing the look up table in a random access memory (RAM) component of the memory device.

12. The method of claim 11, further comprising enabling, by an instruction decoder of the memory device, the one or more of the plurality of activation functions to perform the computation task via the look up table.

13. The method of claim 12, wherein the enabling of the one or more of the plurality of activation functions via the look up table comprises obtaining the output values based on the one or more of the plurality of activation functions for the input values per the computation task via the look up table.

14. An apparatus, comprising:
a memory comprising instructions; and
one or more processors, individually or collectively, configured to execute the instructions and cause the apparatus to:
obtain a computation task;
decode one or more instructions from an instruction set architecture (ISA) to identify one or more of a plurality of activation functions to perform the computation task;
configure one or more of a plurality of programmable computation units (PCUs) of the memory device for implementing the one or more of the plurality of activation functions; and
perform the computation task based on at least in part with implementation of the one or more of the plurality of activation functions.

15. The apparatus of claim 14, wherein the plurality of activation functions comprise at least one of:
a sigmoid activation function,
a softmax activation function,
a hyperbolic tangent activation function,
a gaussian error linear unit (GELU) activation function, or
an exponential linear unit (ELU) activation function.

16. The apparatus of claim 14, wherein the one or more processors, individually or collectively, are configured to execute the instructions and cause the apparatus to configure at least one of the plurality of PCUs to implement two or more of the plurality of activation functions to perform the computation task.

17. The apparatus of claim 16, wherein the one or more processors, individually or collectively, are configured to execute the instructions and cause the apparatus to:
associate a flow controller of the memory device with a dynamic interconnect component of the memory device; and
associate the dynamic interconnect component with the plurality of PCUs.

18. The apparatus of claim 17, wherein the one or more processors, individually or collectively, are configured to execute the instructions and cause the apparatus to configure the dynamic interconnect component based on the computation task, to control data transfer between the plurality of PCUs to perform the computation task.

19. The apparatus of claim 17, wherein the one or more processors, individually or collectively, are configured to execute the instructions and cause the apparatus to arrange an order of execution of each of the plurality of PCUs to perform the computation task, based on the computation task.

20. A non-transitory computer-readable medium comprising instructions that, when executed by a memory device, cause the memory device to perform a method, comprising:
obtaining a computation task;
decoding one or more instructions from an instruction set architecture (ISA) to identify one or more of a plurality of activation functions to perform the computation task;
configuring one or more of a plurality of programmable computation units (PCUs) of the memory device for implementing the one or more of the plurality of activation functions; and
performing the computation task based on at least in part with implementation of the one or more of the plurality of activation functions.
